(19) United States
(12) Patent Application Publication
(10) Pub. No.: US 2004/0042590 A1
(43) Pub. Date: Mar. 4, 2004

(54) Method for operating a device for message storage in a communications terminal, and a communications device

(76) Inventors: Albert Bueckers, Metelen (DE); Andreas Klink, Pullacm (DE)

Correspondence Address: BELL, BOYD & LLOYD, LLC, P. O. BOX 1135, CHICAGO, IL, 60690-1135, US

(21) Appl. No.: 10/230,660

(22) Filed: Aug. 29, 2002

(51) Int. Cl. H04M 1/64

(52) U.S. Cl. 379/67.1

(57) ABSTRACT

A method for operating a device for message storage in a communications terminal, as well as a communications device for carrying out the method, wherein at least one function of the device for message storage is activated via a room monitoring function which is associated with the communications terminal.

### BACKGROUND OF THE INVENTION

Telecommunications devices are known which make it possible for a caller to speak a message or to store such a message in the form of a text or a number message if the call partner to whom he/she wishes to speak is not present.

In general, these are communications terminals with the so-called call answering machine which, for example, has a cassette recorder, digital memory or the like as the storage medium.

In the case of call answering systems, the storage of a message is generally initiated in an absence mode or when a condition which is predetermined by the user occurs; for example, if a call is not answered after ringing a number of times, or if a mobile telephone is switched off.

It is normal in this case for the caller to be made aware by an announcement that he/she can leave a message after a particular tone, in which case the caller then speaks this message, if these are spoken messages, with the recording generally being ended by disconnection of the connection once a message has been spoken.

Once a message has been recorded, the presence of a message on the call answering machine is, in general, indicated immediately, such as by the blinking of a light-emitting diode, so that, when he/she returns, the user of the communications terminal is immediately made aware of the messages and can listen to them.

To do this, the user must be in the immediate vicinity of the appliance, in order to allow the call answering machine to be answered, so that he/she necessarily has to move to the appliance.

An object to which the present invention is directed is to specify a method and an arrangement to ensure an improvement in the convenience of use of a device for message storage.

### SUMMARY OF THE INVENTION

In the method according to the present invention for operating a device for message storage in a communications terminal, at least one function of the device for message storage is activated via a room monitoring function which is associated with the communications terminal.

Since a room monitoring function is used, this ensures at least activation of the device for message storage just by entering the room.

If the function for monitoring the room carries out acoustic monitoring, then conventional devices such as a microphone of a handset or of a hands-free device can be used for this purpose in communications terminals.

When the function of the device is activated for storage, when a value of the sound level of any noise which is detected by the acoustic room monitoring exceeds a threshold value, then this ensures that the device for storing messages is not initiated continually by environmental noise but only above a level at which the probability that someone has entered the room is at a maximum. Better matching to the actual environment can be achieved, for example, by the threshold value being adjustable.

Since the function is activated only when the value of the sound level exceeds the threshold value for the duration of a first time period, it is likewise quite possible to prevent the device for storing messages being initiated accidentally by environmental noises whose levels briefly exceed the threshold value.

Better matching to the actual conditions and individual matching can be achieved via an adjustable time period.

If the noise which is detected by the acoustic room monitoring is supplied to a feature analysis process for comparison with stored features of a reference noise, the probability of accidental initiation can be minimized by analyzing the detected sound for typical noises which occur during occupation or on entry (for example, the opening and closing of doors), so that the function is activated only when the comparison of a noise with the reference noise results virtually in a match; that is to say, within normal tolerances and feasible accuracy requirements.

If the function for monitoring the room carries out visual monitoring, then it will be possible to use for this purpose communications terminals, which will be more widely equipped for visual communication in the future, or communications terminals which already exist and are equipped with cameras for monitoring, without extensive changes.

If the function of the device for storing messages is activated when the visual room monitoring detects a movement in the room, this minimizes the probability of accidental initiation. Furthermore, the function can be started automatically by the user on entering a room, with the visual detection furthermore offering the capability of ensuring, by analysis of the detected image or images, that only an authorized user can initiate functions of the device for storing messages.

In order that the user is informed as soon as the fact that he/she has entered the room has been detected of any messages which have been received, signaling relating to the presence of new messages is carried out as the function; preferably, as an acoustic announcement or by an indication on a mobile part which is carried by the user.

If an operating instruction is accepted once the device for message storage has carried out the signaling process for the duration of a second time period, and the operating instructions are detected by the room monitoring function, this provides a user with the capability of operating the device for storing messages, without having to be located in its vicinity, immediately on entering a room and after receiving the signal. In order to give the user sufficient time, and to avoid the device for message storage from having to wait too long for a reaction, a second time period which lasts for 10 s is sufficient.

If, in the case of acoustic room monitoring, the functions for checking stored messages, particularly play-back, fast-forward and reverse, are activated after receiving spoken phrases which represent operating instructions, this ensures voice control of the device for storing messages which, in particular, is in such a form that a spoken word is subjected to speech analysis, whose result leads to the extraction of features which are compared with stored reference features, which identify valid words, so that, if they match, a function which corresponds to the identified operating instruction is carried out.

If functions for calling up stored messages are activated during visual room monitoring, particularly play-back, fast-forward and reverse, after receiving gestures and/or body language which represent/represents operating instructions, the device for storing messages also can be operated from a greater distance, with the gesture and/or body language being detected via so-called optical tracking, in which a number of points on a moving object are analyzed as a raster, and whose positions with respect to one another are determined and compared with stored reference data which determines valid gestures and/or variants of the body language, so that a function which corresponds to the identified operating instruction is carried out if a match is found.

The communications device according to one embodiment of the present invention has a communications terminal with a device for message storage, a room monitoring function, which is associated with the communications terminal, as well as a device for controlling activation of at least one function of the device for message storage via the room monitoring function.

If the device for message storage is in the form of a cordless base station which operates, in particular, in accordance with DECT, with the room monitoring function, a “Babyphone” function, being in the form of a cordless mobile part which is coupled to a charging device, particularly a mobile part operating in accordance with DECT, this allows the method according to the present invention to be implemented in a simple and cost-effective manner.

A device for message storage, which is in the form of a wire-connected communications terminal with an integrated loudspeaker and microphone, with the room monitoring function being carried out by the microphone, likewise allows the method according to the present invention to be implemented in a simple and cost-effective manner.

The communications device allows non-contacting activation of a function of the device for storing messages.

Additional features and advantages of the present invention are described in, and will be apparent from, the following Detailed Description of the Invention and the Figures.

### BRIEF DESCRIPTION OF THE FIGURES

FIG. 1 shows a flowchart of the method according to the present invention.

FIG. 2 shows an arrangement with the communications device according to the present invention.

### DETAILED DESCRIPTION OF THE INVENTION

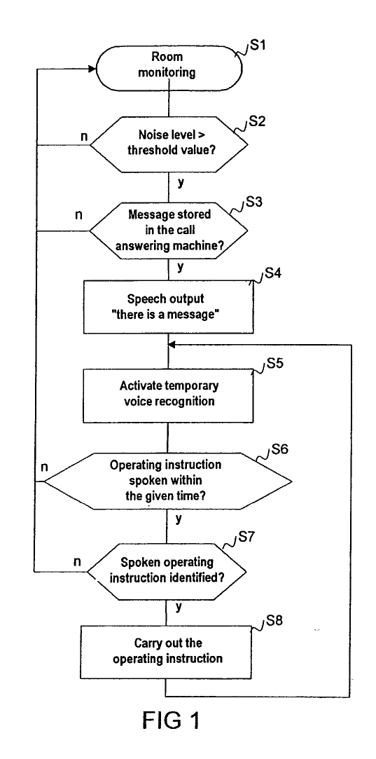

FIG. 1 shows a flowchart which illustrates one embodiment of the method for operating a device for message storage in a communications terminal.

The method is used when the communications appliance is ensured in an absence mode and other conditions, which are set by the user, are satisfied.

In a first step S1, a first communications terminal is in a room monitoring mode, which has been selected by someone using the communications terminal and, for example, when the method is implemented in a first communications terminal, which, as a cordless base station which in conjunction with a mobile part that has been placed in a charging cell, carries out a “Babyphone” functionality, is initiated when the mobile part has also been placed in the charging cell in the absence mode.

Alternatively, this also may be a wire-connected telephone with an integrated call answering machine, such as in order to provide a hands-free function or a room monitoring function which is carried out by an authorized person via the call answering machine when called and initiated, which telephone has both a microphone and a loudspeaker.

Based on this background process, which is, for example, interrupt-controlled on a continuous basis, during the state in which the absence mode is active, the noise level which is detected by the mobile part that has been placed down is compared in a second step S2 which is carried out as an endless loop, with a threshold value which can be adjusted at the user end. A check is then carried out in a third step S3, if the threshold value is exceeded, to determine whether spoken messages are present, so that an announcement function of the call answering machine emits an appropriate message through the loudspeaker, in a fourth step S4.

When the announcement ends, a timer is checked in a fifth step S5 and an implemented voice recognition function is activated for a time interval of approximately 10 s, that is to say temporarily, so that the user can listen to and/or select and/or erase the stored message or messages by speaking the phrases “play-back”, “fast-forward”, “reverse”, “delete” and other commands which are known and normal in the context of listening to spoken messages.

A sixth step S6 checks whether a user has spoken such a command within the time interval. If it is found that the time has passed without any command being spoken, and it can be assumed that there is no desire to listen to the messages or to manipulate them, such as to delete them, the process jumps to the initial state, in the first step S1.

If the user has spoken one of these commands, this is detected by the loudspeaker in a seventh step S7 and the command is subjected to feature analysis, which results in a vector that characterizes the word or the phrase, and this is compared with stored reference vectors for permissible words and/or phrases.

If the comparison process finds a vector match, as is ensured, by way of example, when virtually all the values of the vectors essentially match, the corresponding function of the call answering machine is carried out in an eighth step S8.

After this has been done, the method is repeated from the fifth step S5, since further commands could follow.

If the operation of the call answering machine is restricted to only a single function which can be initiated by speaking a command, in general the “play-back” function, then, alternatively, the process can revert to the initial state of the first step S1 once this function has been carried out.

If no command is spoken in the given time period, or the comparison that is carried out in the seventh step S7 does not lead to a match, the process likewise reverts to the initial state in the first step S1.

As an alternative to acoustic room monitoring and voice input, visual room monitoring can be used in which an input is produced either by the voice or via gestures or body language. In a system such as this, a comparison is then carried out in a process which is comparable to voice recognition; determination of characteristic features, possibly vector formation, or comparison with reference data (vectors).

A combination of aspects of acoustic and visual monitoring is also feasible, so that, for example, entry to the room can be detected visually, while the operating instructions are detected acoustically during the time interval, and vice versa.

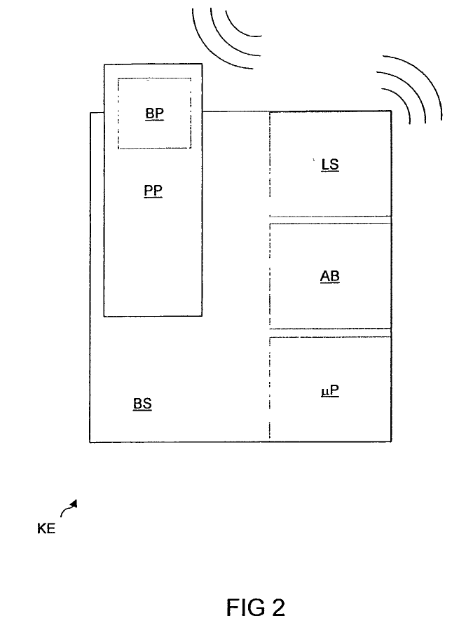

FIG. 2 shows the communications device KE according to the present invention, which includes a cordless base station BS which operates in accordance with the “Digital European Cordless System” DECT Standard, as well as a registered cordless mobile part PP, which is placed in the charging shell of the base station BS. The base station KE is furthermore designed such that, as a message storage device, it has an integrated call answering function AB, which is controlled by a microprocessor μP.

Placing the mobile part PP in the charging shell of the base station BS initiates and provides a function BP, which is referred to as a “Babyphone”, which detects noises in the room via a conventional microphone that is integrated in the mobile part PP, and thus provides the monitoring function BP associated with the base station.

A device for controlling activation of the call answering function AB is integrated in the microprocessor μP, so that a loud speaker LS in the base station BS can produce an announcement relating to any messages that are present when a noise level is exceeded.

Alternatively, the activation can be effected wherein also a microprocessor of the cordless mobile part PP can integrate the device for controlling activation of the call answering function AB.

As a further alternative (not illustrated) it is also possible to use a wire-connected communications terminal, particularly a landline telephone for carrying out the method according to the present invention, which is equipped with a call answering function as well as with a loudspeaker and a microphone.

Although the present invention has been described with reference to specific embodiments, those of skill in the art will recognize that changes may be made there too without departing from the spirit and scope of the present invention as set forth in the hereinafter appended claims.

1. A method for operating a device for message storage in a communications terminal, the method comprising the steps of:
associating a room monitoring function with the communications terminal; and
activating at least one function of the device for message storage via the room monitoring function.

2. A method for operating a device for message storage in a communications terminal as claimed in claim 1, wherein the room monitoring function carries out acoustic monitoring.

3. A method for operating a device for message storage in a communications terminal as claimed in claim 2, wherein the at least one function is activated when a value of a sound level of a noise which is detected by the acoustic room monitoring exceeds an adjustable threshold value.

4. A method for operating a device for message storage in a communications terminal as claimed in claim 3, wherein the at least one function is activated when the value of the sound level exceeds the threshold value for a duration of a first time period.

5. A method for operating a device for message storage in a communications terminal as claimed in claim 4, wherein the time period is adjustable.

6. A method for operating a device for message storage in a communications terminal as claimed in claim 2, the method further comprising the step of supplying noise which is detected by the acoustic room monitoring to a feature analysis process for comparison with stored features of a referenced noise, wherein the at least one function is activated when a comparison results in a substantial match between any noise and the referenced noise.

7. A method for operating a device for message storage in a communications terminal as claimed in claim 1, wherein the room monitoring function carries visual monitoring.

8. A method for operating a device for message storage in a communications terminal as claimed in claim 7, wherein the room monitoring function is activated when the visual room monitoring detects a movement in the room.

9. A method for operating a device for message storage in a communications terminal as claimed in claim 1, wherein signaling relating to a presence of new messages is carried out as the room monitoring function.

10. A method for operating a device for message storage in a communications terminal as claimed in claim 9, the method further comprising the steps of:
accepting an operating instruction for a second time period after carrying out the signaling, via the device for message storage; and
detecting the operating instructions using the room monitoring function.

11. A method for operating a device for message storage in a communications terminal as claimed in claim 10, wherein the second time period lasts for ten seconds.

12. A method for operating a device for message storage in a communications terminal as claimed in claim 10, wherein for acoustic room monitoring, functions for calling up stored messages, including play back, fast forward and reverse, are activated after receiving spoken phrases which represent operating instructions.

13. A method for operating a device for message storage in a communications terminal as claimed in claim 10, wherein for visual room monitoring, functions for calling up stored messages, including play back, fast forward and reverse, are activated after receiving at least one of gestures and body language which represent operating instructions.

14. A communications device having a communications terminal, comprising:
a device for message storage;
a room monitoring function associated with the communications terminal; and
a device for controlling activation of at least one function of the device for message storage via the room monitoring function.

15. A communications device as claimed in claim 14, wherein the device for message storage is a cordless base station which operates in accordance with DECT, and the room monitoring function is a Babyphone function effected as a cordless mobile part which is coupled to a charging device and which operates in accordance with DECT.

16. A communications device as claimed in claim 14, wherein the device for message storage is a wire-connected communications terminal with an integrated loud speaker and microphone, and the room monitoring function is effected by the microphone.
